(19) United States
(12) Patent Application Publication
(10) Pub. No.: US 2014/0019348 A1
(43) Pub. Date: Jan. 16, 2014

(54) TRUSTED THIRD PARTY PAYMENT SYSTEM

(71) Applicant: Sean-Michael Daley, Irving, TX (US)

(72) Inventor: Sean-Michael Daley, Irving, TX (US)

(73) Assignee: RUMBLELOGIC, INC. DBA PAYTAP, Carrollton, TX (US)

(21) Appl. No.: 13/550,417

(22) Filed: Jul. 16, 2012

(51) Int. Cl. G06Q 20/14

(52) U.S. Cl. 705/40

(57) ABSTRACT

A trusted third party payment system includes one or more network interfaces that communicate with a device to receive bill information about bills of a bill owner and to communicate with devices to receive bill helper payment instrument information and to communicate with systems operated by billers of the bill owner, and a central processing unit that uses the payment instrument information to pay the bills to the billers systems with funds of the bill helpers. The bill owner, the bill helpers, the billers and the trusted third party are all distinct entities. The system also receives bill helper contact information and electronically communicates to the bill helpers (e.g., email, text message, Facebook or Twitter message) that the bill owner has requested help paying the bills. For at least one of the bills, the CPU pays partial amounts of the bill with funds of each of multiple bill helpers.

### BACKGROUND OF THE INVENTION

Everyday, across this and every other country, families and friends help one another out by giving or loaning money to pay essential bills. The payment may be one-off emergencies or longer-term arrangements that must be addressed month after month, year after year. This process can be difficult for both participants in the transaction. Often there are emotional issues, embarrassment, shame, pride that get in the way of asking for help. In other contexts, for example parents helping college students or children helping elderly parents, the difficulties are mostly logistics and complexity. In addition, vendors of goods and services are facing rising default rates and need to maximize their returns while retaining customers, particularly through difficult financial times, rather than alienating them by discontinuing their goods or services. Finally, there are philanthropic individuals and organizations that want to help needy people and need a way to find them that enables them to know the funds they provide are really going toward essential needs. What is needed is a system to address these and related problems.

### BRIEF SUMMARY OF INVENTION

A trusted third party payment system allows people that own bills to “tap” friends, family and others to help pay part or all of their commitments, minimizing the cost, embarrassment, complexity and logistics of the payment. A system has been created that easily allows people to put their bills online, identify friends and family members they want to ask for assistance, and notify those individuals. The system also enables those who are asked for assistance, “bill helpers,” to easily provide and control the flow of the help they give, all while adding ease, immediacy, accountability, transparency, and predictability.

In one aspect the present invention provides a trusted third party payment system. The system includes one or more network interfaces configured to communicate with a device to receive bill information about bills of a bill owner and to communicate with a plurality of devices to receive payment instrument information of each of a plurality of bill helpers and to communicate with systems operated by billers to whom the bills are owed by the bill owner. The system also includes a central processing unit (CPU) configured to use the payment instrument information to pay the bills to the systems operated by the billers with funds of the bill helpers. The bill owner, the bill helpers, the billers and the trusted third party are all distinct entities.

In another aspect the present invention provides a method. The method includes receiving, by a computer system, bill information about bills of a bill owner. The method also includes receiving, by the computer system, payment instrument information of each of a plurality of bill helpers. The method also includes paying the bills, by the computer system, with funds of the bill helpers using the payment instrument information. The computer system is operated by a trusted third party. Each of the bills is owed to a biller. The bill owner, the bill helpers, the billers and the trusted third party are all distinct entities.

In yet another aspect the present invention provides a computer-readable memory medium comprising program instructions, wherein the program instructions are executable by a processor to implement receiving, by a computer system, bill information about bills of a bill owner; receiving, by the computer system, payment instrument information of each of a plurality of bill helpers; and paying the bills, by the computer system, with funds of the bill helpers using the payment instrument information. The computer system is operated by a trusted third party. Each of the bills is owed to a biller. The bill owner, the bill helpers, the billers and the trusted third party are all distinct entities.

In yet another aspect the present invention provides a method. The method includes receiving, by a computer system, payment instrument information of each of a plurality of contributors. The method also includes funding, by the computer system, a debit card in the name of a person, with funds of the contributors using the payment instrument information. The computer system is operated by a trusted third party. The person, the contributors and the trusted third party are all distinct entities.

In yet another aspect the present invention provides a method. The method also includes receiving, by a computer system, bill information about a bill of a bill owner. The method also includes electronically communicating, by the computer system, to a bill helper, using the contact information, that the bill owner has requested help paying the bill. The method also includes receiving, by the computer system, payment instrument information of the bill helper. The method also includes paying the bill, by the computer system, with funds of the bill helper using the payment instrument information. The computer system is operated by a trusted third party. The bill is owed to a biller. The bill owner, the bill helper, the biller and the trusted third party are all distinct entities.

In yet another aspect the present invention provides a method. The method includes receiving, by the computer system, payment instrument information of each of a plurality of contributors. The method also includes funding, by the computer system, an account held by an entity that provides goods and/or services, with funds of the contributors using the payment instrument information. The method also includes withdrawing funds from the account in response the entity providing goods and/or services to beneficiaries. The computer system is operated by a trusted third party. The goods/services provider entity, the contributors, the beneficiaries and the trusted third party are all distinct entities.

### BRIEF DESCRIPTION OF THE DRAWINGS

FIG. 1 is a block diagram illustrating a financial network that includes a trusted third party payment (TTPP) system according to an embodiment of the present invention.

FIG. 2 is a flowchart illustrating operation of the TTPP system of FIG. 1 to enable bill helpers to pay the bills of bill owners according to the present invention.

FIG. 3 is a flowchart illustrating in more detail the operation at block 214 of FIG. 2 according to one embodiment of the present invention.

FIG. 4 is a flowchart illustrating in more detail the operation at blocks 226 and 228 of FIG. 2 according to one embodiment of the present invention.

FIG. 5 is a flowchart illustrating operation of the TTPP system of FIG. 1 to facilitate payment to billers of bill owner bills by bill helpers according to an alternate embodiment of the present invention.

FIGS. 6 through 20 are screen shots of various aspects of the user interface provided by the TTPP system of FIG. 1 to bill owners and bill helpers.

### DETAILED DESCRIPTION OF THE EMBODIMENTS

### Glossary

Biller—A company, person or other legal entity that has issued a bill for payment of a good or service provided. Examples of billers may include, but are not limited to, utility companies, phone companies, mortgage companies, car loan companies, credit card companies, retail merchants, and the like.

Bill owner—A person or other legal entity to which a biller has issued a bill that has not been paid. That is, a bill owner is the entity that owes payment for the bill.

Bill helper—A person or organization or other legal entity that pays a bill owner's bill to a biller on behalf of the bill owner. The bill helper is distinct from the bill owner. Examples of bill helpers are family members and friends of the bill owner and philanthropic persons and organizations.

Trusted third party—a legal entity that develops and operates an electronic payment system that facilitates the payment of bill owner bills by bill helpers. The trusted third party is licensed by each of the jurisdictions, where required, in which it transfers money to do so, either as a licensee by the jurisdiction or as a sub-licensee or agent. The trusted third party is a distinct legal entity from the bill owners and bill helpers; and, the bill owner, not the trusted third party, owes the bill to the biller.

Memory Medium—Any of various types of memory devices or storage devices. The term “memory medium” is intended to include an installation medium, e.g., a CD-ROM, floppy disk, or tape device; a computer system memory or random access memory such as DRAM, DDR RAM, SRAM, EDO RAM, Rambus RAM, etc.; or a non-volatile memory such as a magnetic media, e.g., a hard drive, optical storage, FLASH memory, or solid-state disk (SSD). The memory medium may comprise other types of memory as well, or combinations thereof. In addition, the memory medium may be located in a first computer in which the programs are executed, and/or may be located in a second different computer that connects to the first computer over a network, such as the Internet. In the latter instance, the second computer may provide program instructions to the first computer for execution. The term “memory medium” may include two or more memory mediums that may reside in different locations, e.g., in different computers that are connected over a network.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, C#, PASCAL, FORTRAN, COBOL, JAVA, assembly language, etc.; graphical programs (programs written in graphical programming languages); assembly language programs; programs that have been compiled to machine language; scripts; and other types of executable software. A software program may comprise two or more software programs that interoperate in some manner. Note that a computer and/or software program may implement various embodiments described herein. A software program may be stored as program instructions on a memory medium.

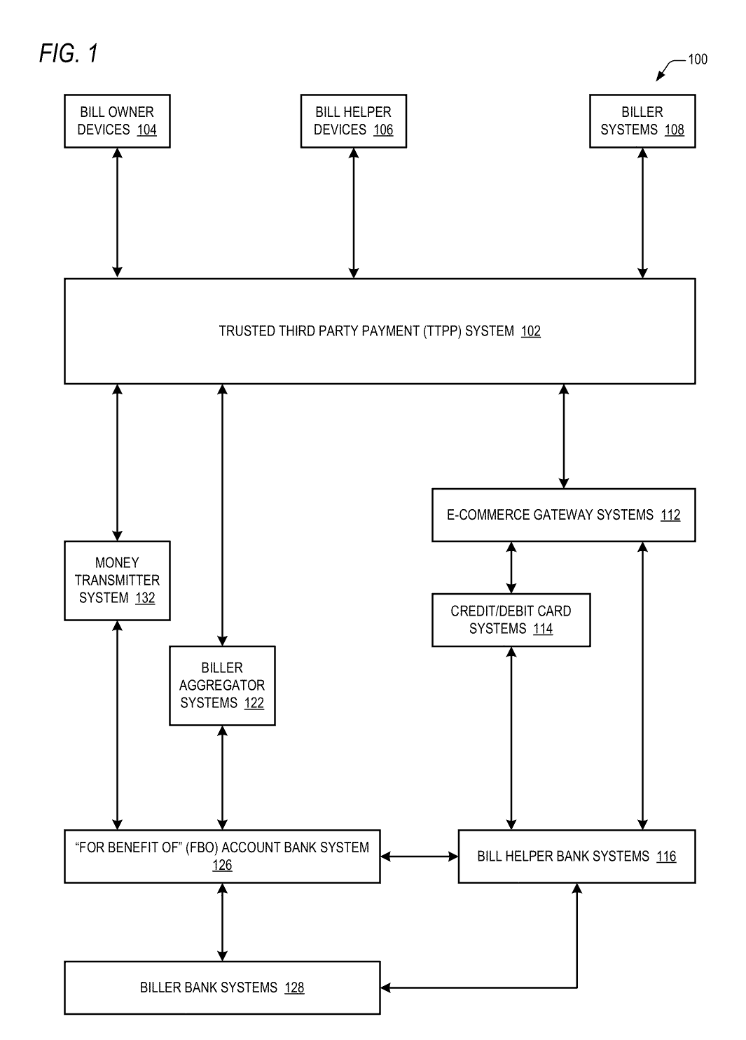

Referring now to FIG. 1, a block diagram illustrating a financial network 100 that includes a trusted third party payment (TTPP) system 102 according to an embodiment of the present invention is shown. The network 100 includes many computer systems and electronic devices in electronic communication with one another, that include: the TTPP system 102; bill owner devices 104; bill helper devices 106; one or more biller systems 108; an e-commerce gateway system 112; credit/debit card systems 114; bill helper bank systems 116; a biller aggregator system 122; a “for benefit of” (FBO) account bank system 126; biller bank systems 128; and a money transmitter system 132. Each of these systems is one or more computing devices capable of performing the functions described herein. For example, the systems may include, but are not limited to, a mainframe computer, mini-computer, super-computer, desktop computer, laptop computer, notebook computer, tablet computer, personal digital assistant, cell phone or other mobile device. Furthermore, each of the systems may be a combination of such computers in communication via a communications network, such as a local area network, wide area network, and/or telecommunications network. In one embodiment, the bill owner devices 104 and the bill helper devices 106 execute a web browser that accesses web pages provided by the payment system 102. Additionally, the biller systems 108 may execute a web browser that accesses web pages provided by the payment system 102.

The bill owner devices 104, bill helper devices 106, biller systems 108, e-commerce gateway systems 112, biller aggregator systems 122 and money transmitter system 132 are in communication with the TTPP system 102. The various bank systems—namely the credit/debit card systems 114, bill helper bank systems 116, FBO account bank system 126 and biller bank systems 128—are in communications with one another. The e-commerce gateway systems 112 are in communication with the credit/debit card systems 114 and the bill helper bank systems 116. The money transmitter system 132 and biller aggregator systems 122 are in communication with the TTPP system 102 and FBO account bank system 126. These various systems communicate via communications networks, such as local area networks, wide area networks, and/or telecommunications networks, such as the Internet, cell phone networks, or private telecommunications networks.

The bill owners operate the bill owner devices 104 to provide to the TTPP system 102 information about billers, bills and potential bill helpers that may be willing to help pay the bills. The bill helpers operate the bill helper devices 106 to obtain from the TTPP system 102 information about the bills of a bill owner and to provide to the TTPP system 102 payment instrument information with which the bill helper will pay the bill owner bills and to indicate which bills and what amount of each bill the bill helper is willing to pay. The billers operate the biller systems 108 in order to receive bill payments serviced by the TTPP system 102. Additionally, the biller systems 108 may provide to the TTPP system 102 bill owner bill information and track the progress of bill payments via a dashboard provided by the TTPP system 102, e.g., to see how many requests have been sent out to potential bill helpers for each bill owed to the biller and to track payments made.

E-commerce gateway providers—also referred to as payment gateway providers or merchant service providers or other similar terms—operate the e-commerce gateway systems 112 to provide processing of credit card, debit card, and automatic clearing house (ACH) payments. The e-commerce gateway providers authorize payments and protect payment instrument information, such as credit/debit card or bank account information, by encrypting the information as it is passed between the TTPP system 102 and the payment processor. Examples of e-commerce gateway providers are Online Resources Corp. (ORCC), Credit Management Systems (CMS), Authorize.net, CyberSource, Chase Paymentech, Elavon, First Data Corporation and Global Payments, Inc. The credit/debit card systems 114 are systems operated by VISA®, MasterCard®, Novus®, and Centurion®, among others. Although FIG. 1 shows a single block as the e-commerce gateway systems 112 and a single block as the credit/debit card systems 114, it should be understood that multiple transaction processors might be involved in the transactions that flow between the TTPP system 102 and the bill helper bank system 116.

A biller aggregator operates the biller aggregator systems 122 to facilitate payments from the FBO account bank system 126 to the biller bank systems 128. The biller aggregator has relationships with multiple billers who have authorized the biller aggregator to receive payments on behalf of the billers. Examples of biller aggregators are Online Resources Corp. (ORCC), FiServ, Inc. and MasterCard RPPS. It should be understood that the network 100 might also include the larger banking system of a particular country, such as the Federal Reserve Bank system in the United States of America, and/or the international banking system.

The FBO (“For the Benefit Of”) account is a holding account in which funds are received from bill helper accounts at the bill helper bank systems 116 and from which funds are transmitted to biller accounts at biller bank systems 128. The trusted third party operates the TTPP system 102 to cause these transfers of funds into and out of the FBO account. The trusted third party is a money transmitter licensed by each of the jurisdictions, where required, from which it transfers money into the FBO account or to which it transfers money from the FBO account and/or is a sub-licensee or agent of a money transmitter having a money transfer license or money transmission license or money-transferring license (different jurisdictions have different terminology and requirements) from each of the jurisdictions and which operates the money transmitter system 132. The TTPP system 102 provides to the money transmitter system 132 a report that includes the information of all payments into the FBO account system 126. The money transmitter system 132 also receives a report from the FBO account system 126 of payments into and out of the FBO account. This enables the money transmitter to audit the transfers made by the TTPP system 102 into the FBO account, for example to detect money laundering or fraudulent transactions. Examples of money transmitters are PreCash Inc., ADP Payroll Services Inc., Amazon Payments Inc., Facebook Payments Inc., MoneyGram Payment Systems Inc., PayPal Inc. Western Union Financial Services Inc. and Xoom Corporation. As mentioned above, in an alternate embodiment the trusted third party is a licensed money transmitter, and the trusted third party, rather than a sub-licensor or principal money transmitter, holds the FBO account. In one embodiment, a first FBO account is maintained for money transfers in which the trusted third party is licensed as a money transmitter in all relevant jurisdictions, and a second FBO account is maintained for money transfers involving jurisdictions in which the trusted third party is a sub-licensee or agent of another money transmitter. The trusted third party is a distinct legal entity from the bill owners and bill helpers; and, the bill owner, not the trusted third party, owes the bill to the biller. In one embodiment, the trusted third party that developed and will soon operate the TTPP system 102 is Rumblelogic, Inc DBA PayTap, Inc. of Carrollton, Tex.

The TTPP system 102 includes hardware computer systems and software programs executed by the hardware systems to perform the functions described herein. The TTPP system 102 includes storage devices capable of storing data processed by the software programs and of storing the software programs themselves. Additionally, the trusted third party may provide mobile applications to operate on the bill owner devices 104, bill helper devices 106 and/or the biller systems 108.

The following use cases are envisioned for the TTPP system 102 described herein, although the uses are not limited to those listed.

An individual needing help paying his bills may create an account on the TTPP system 102, enter bill information and potential bill helper contact information and have the bills paid by bill helpers via the TTPP system 102.

Companies (billers) that have customers behind in their payments do not want to refer their customers to a collection agency because they will likely lose the account if they do so, and if they do get payment it will likely be pennies on the dollar, may be motivated to encourage their customers (bill owners) to use the TTPP system 102. For example, the company website may promote the TTPP system 102 and customer service representatives of company may direct customers who are behind on their payments to the TTPP system 102 to get help paying their bills from friends and family or other bill helpers. Furthermore, as mentioned above, the company may be willing to pay the trusted third party a fee for the services provided by the TTPP system 102.

Parents and grandparents of college students may use the TTPP system 102 to identify critical and discretionary expenses and receive reminders from the TTPP system 102 to ensure payments are made in time.

Grown children of elderly parents may avoid the logistical difficulties of coordinating the payments of multiple siblings for different bills, partial payments, and varying payment schedules by using the TTPP system 102. Additionally, the adult children may enjoy the logistical benefits and simplicity of the TTPP system 102 to pay their parents' bills from the convenience of their bill helper devices 106 for their parents who have medical conditions that render them physically unable to pay their bills.

Community and charity groups organizing contributions to needy individuals and/or families may list their bills on the TTPP system 102 and thereby enable their community of givers to easily select a bill owner to help and to quickly and easily pay a bill and audit the payment of the bill owner's bills.

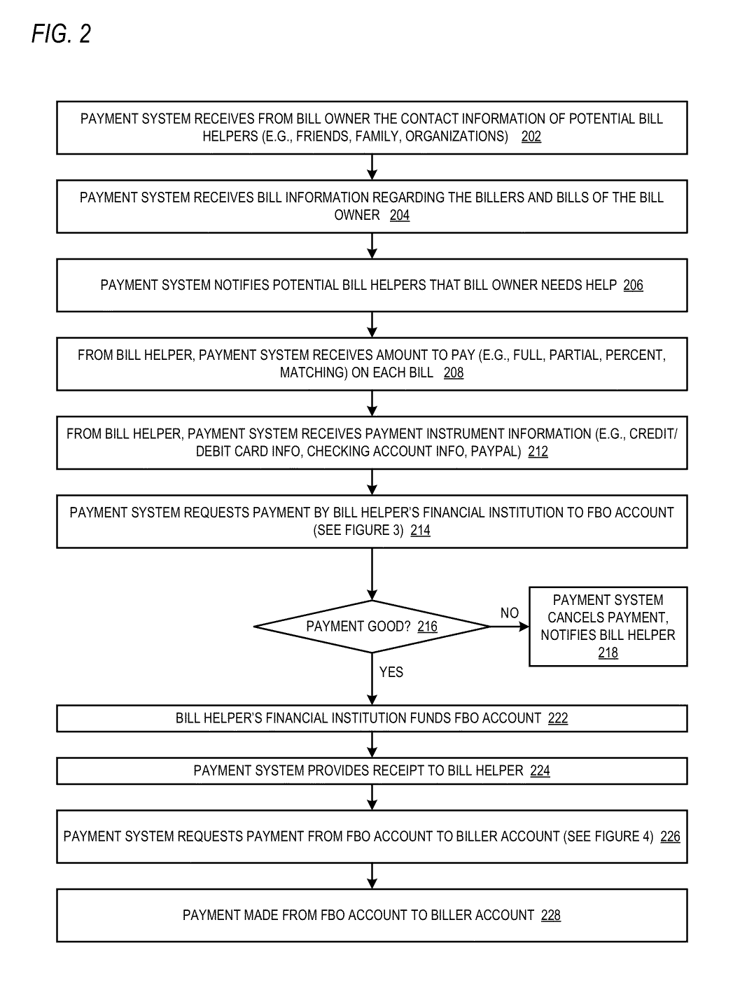

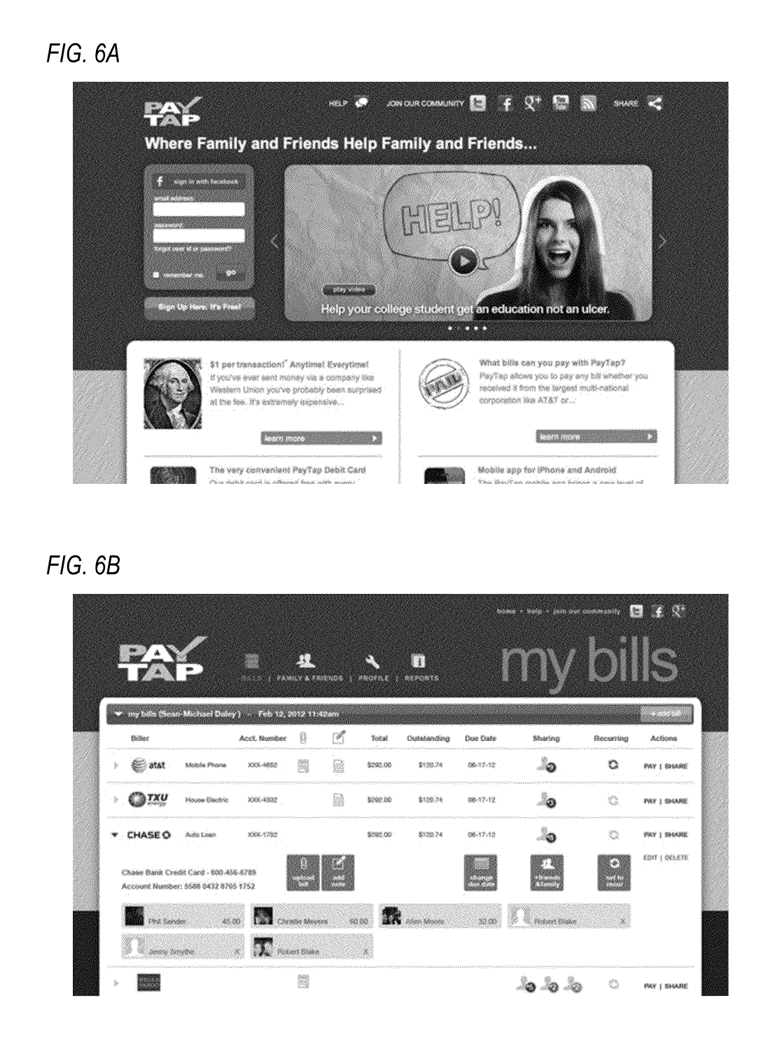

Referring now to FIG. 2, a flowchart illustrating operation of the TTPP system 102 of FIG. 1 to enable bill helpers to pay the bills of bill owners according to the present invention is shown. FIG. 6A is a screen shot illustrating a home page of a website provided for users of the TTPP system 102 according to one embodiment. As shown, the TTPP system 102 provides ways for the user to learn about the TTPP system 102, to sign up to create an account, and/or to login to the user's account on the TTPP system 102 by providing security credentials. As also shown, the TTPP system 102 provides the ability to sign in with the user's Facebook account or other social media account. FIG. 6B is a screen shot illustrating another web page provided by the TTPP system 102 for a user that lists the bill owner's bills once entered into the TTPP system 102, as described in more detail herein, and to update information about the bills, such as changing the due date of the bill, updating the bill helpers that are notified about the bills, toggling the recurring nature of the bill, adding a note about the bill and uploading an image of a new bill. Flow begins at block 202.

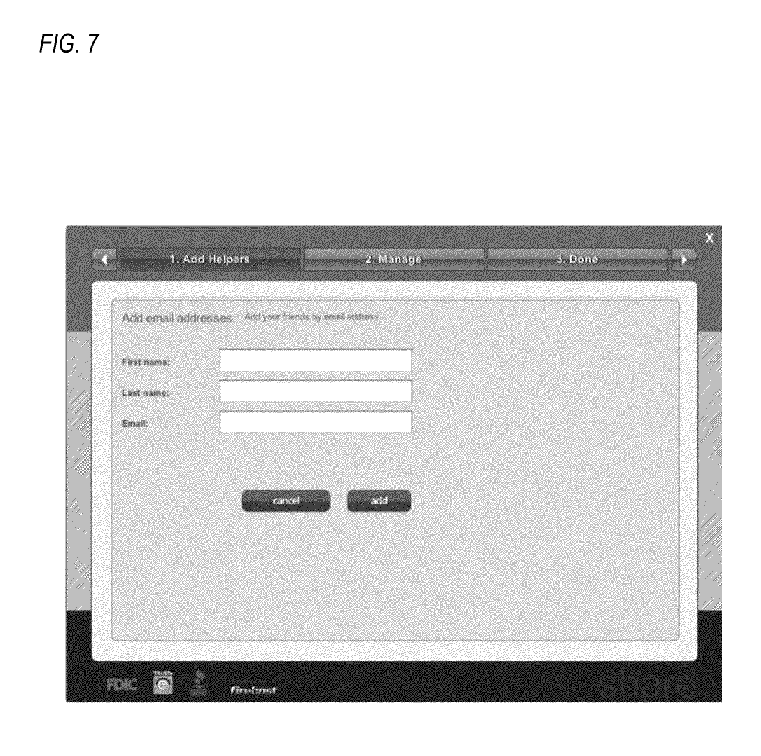

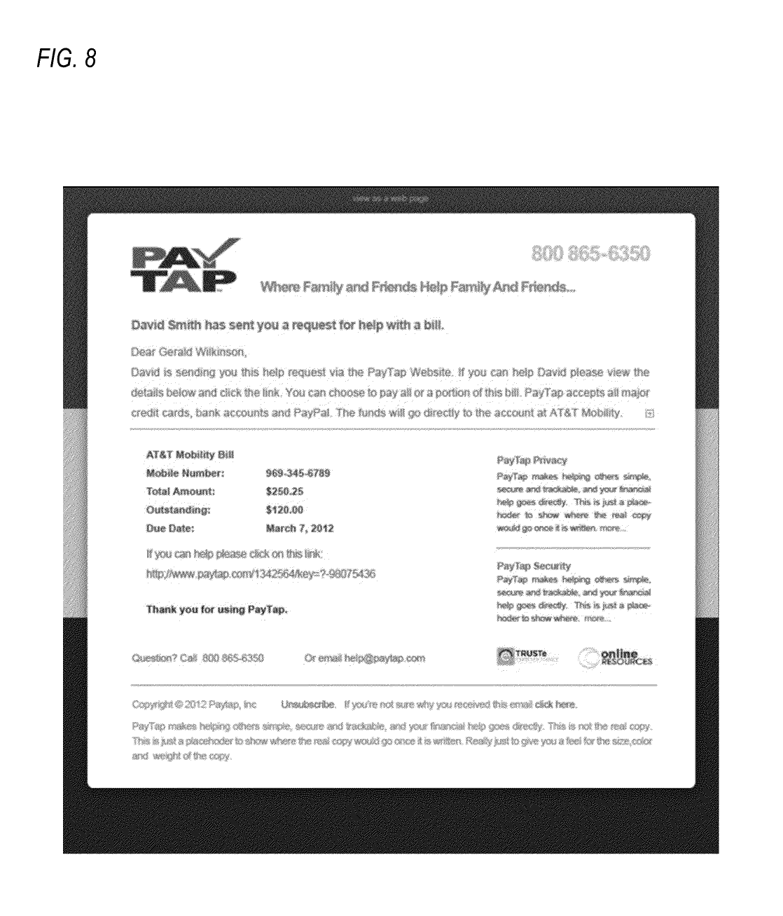

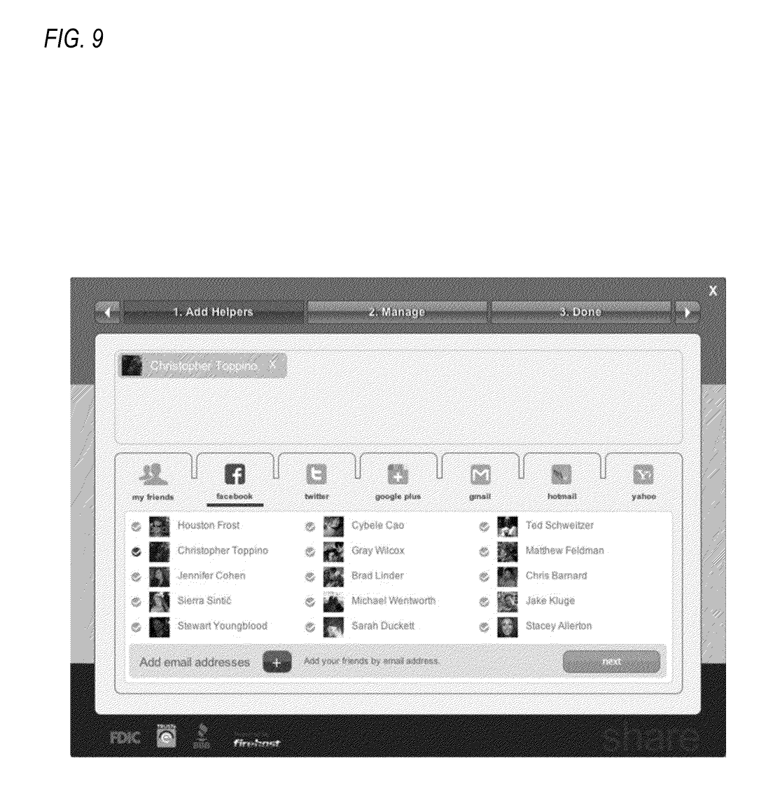

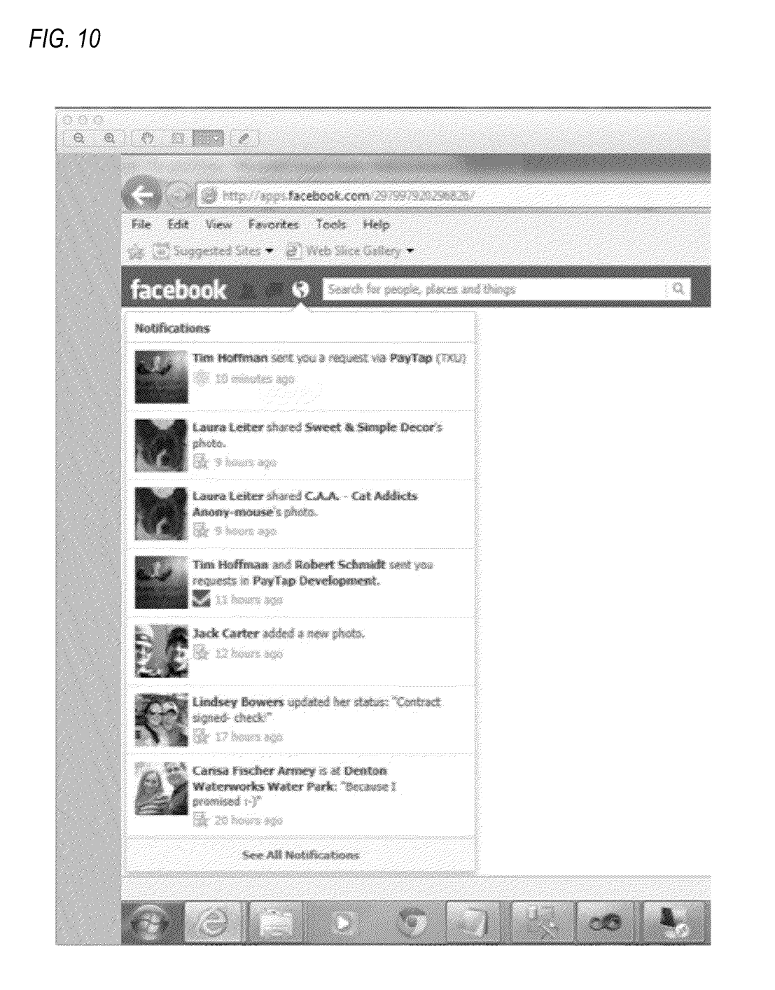

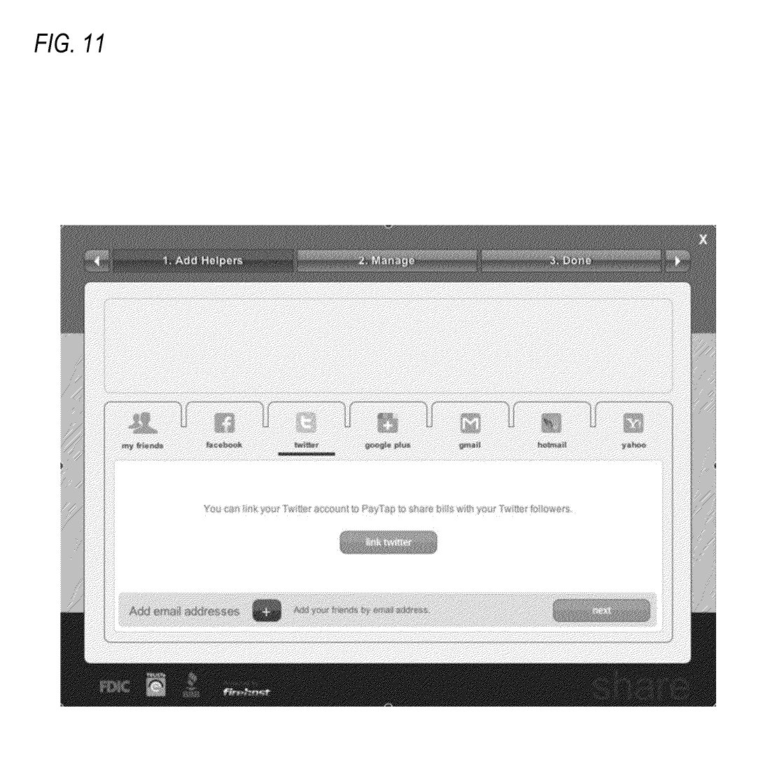

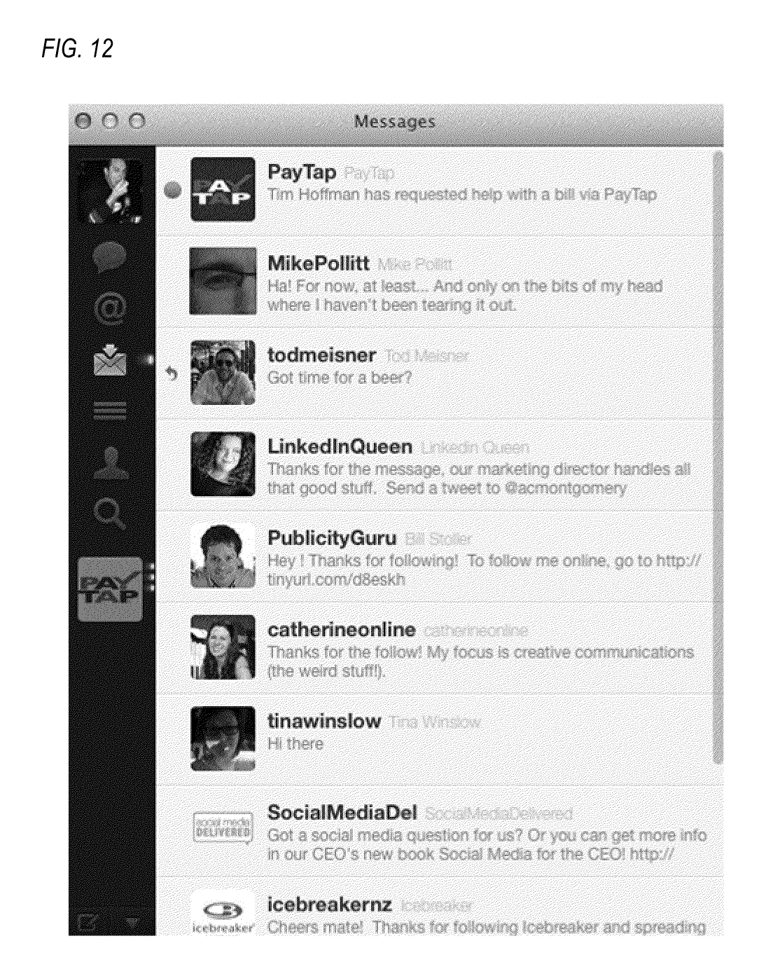

At block 202, the bill owner accesses the TTPP system 102 using a bill owner device 104. The TTPP system 102 receives information from each bill owner that enables the TTPP system 102 to contact potential bill helpers that the bill owner thinks may be willing to help the bill owner pay his bills. In one embodiment, the TTPP system 102 provides a user interface on the bill owner device 104 that enables the bill owner to enter the name and email address of potential bill helpers into the TTPP system 102, as shown in the screen shot of FIG. 7. Subsequently, the TTPP system 102 sends an email message to the potential bill helper's device 106 about the bill owner's bills. For example, the screen shot of FIG. 8 shows an email message sent to a potential bill helper regarding an AT&T Mobility bill that needs to be paid, including the bill owner's name, the mobile number, total amount of the bill, the outstanding amount due, the due date of the bill, and a link the potential bill helper can click on to go to the TTPP system 102 to pay the bill. In one embodiment, the bill owner may provide Facebook® account information to the TTPP system 102 to enable the TTPP system 102 to determine the bill owner's Facebook friends. The TTPP system 102 user interface then displays the Facebook friends for the bill owner, and the bill owner clicks on the Facebook friends to add to the list of potential bill helpers, as shown in the screen shot of FIG. 9. Subsequently, the TTPP system 102 sends a Facebook notification to the selected friends about the bills of the bill owner that need to be paid. For example, the screen shot of FIG. 10 shows a Facebook notification on the Facebook page of a potential bill helper regarding a utility bill to TXU Energy that needs to be paid. In one embodiment, as shown in the screen shot of FIG. 11, the user interface of the TTPP system 102 enables the bill owner to link his Twitter account to the TTPP system 102 to share bills with potential bill helpers who are Twitter followers of the bill owner. The TTPP system 102 subsequently sends a Twitter tweet, or message, as shown in the screen shot of FIG. 12, about the request for help with a bill via the TTPP system 102. In other embodiments, the TTPP system 102 may provide notifications to potential bill helpers about the bill owner's bills via other social media outlets. Furthermore, the bill owner may provide the cell phone number of potential bill helpers so that the TTPP system 102 may send text messages to them about the bill owner's bills. Alternatively, the TTPP system 102 may receive potential bill helper contact information from the bill helpers themselves. For example, a bill helper may be an individual or charitable organization that wants to help a bill owner whom the bill helper does not even know. Flow proceeds to block 204.

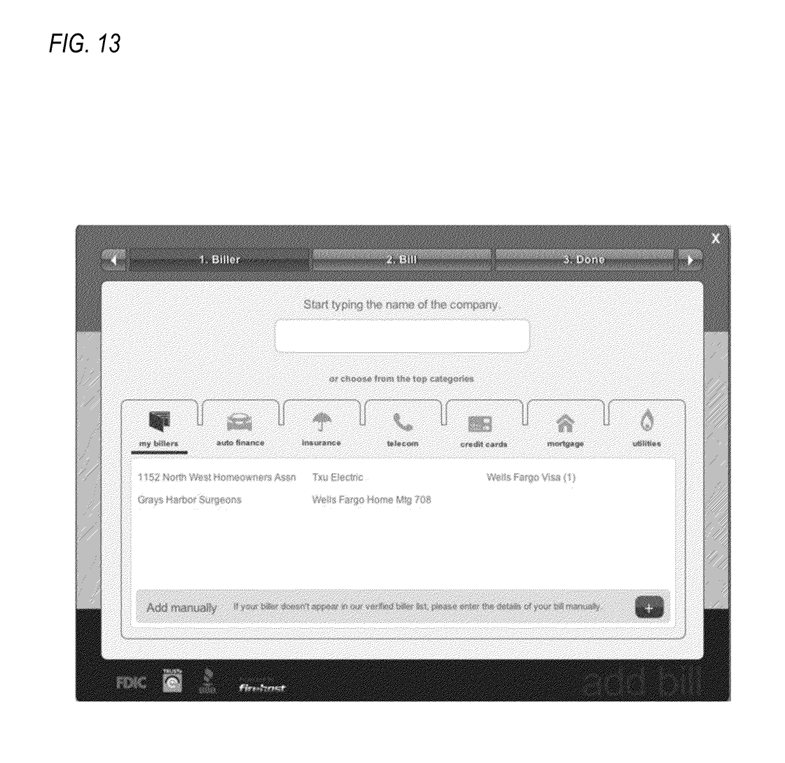

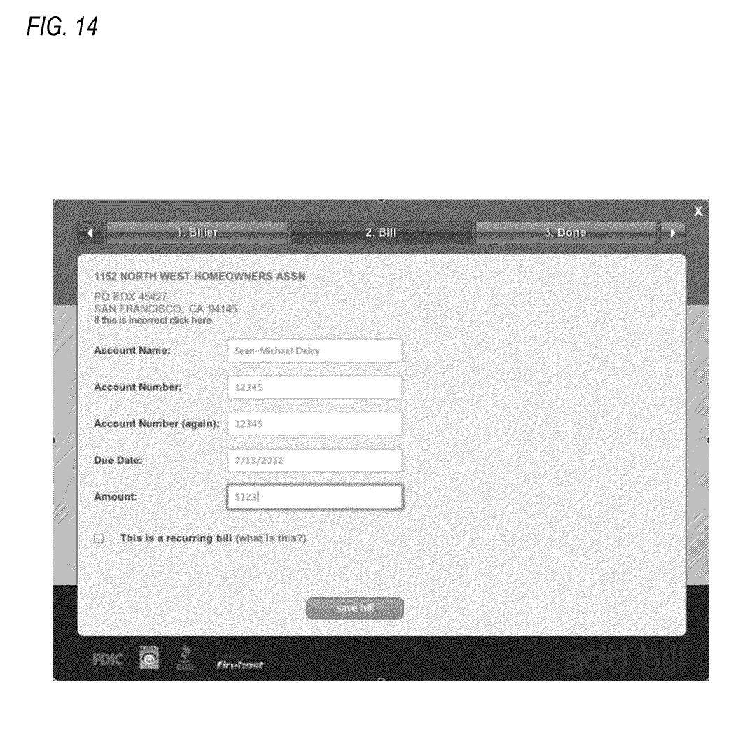

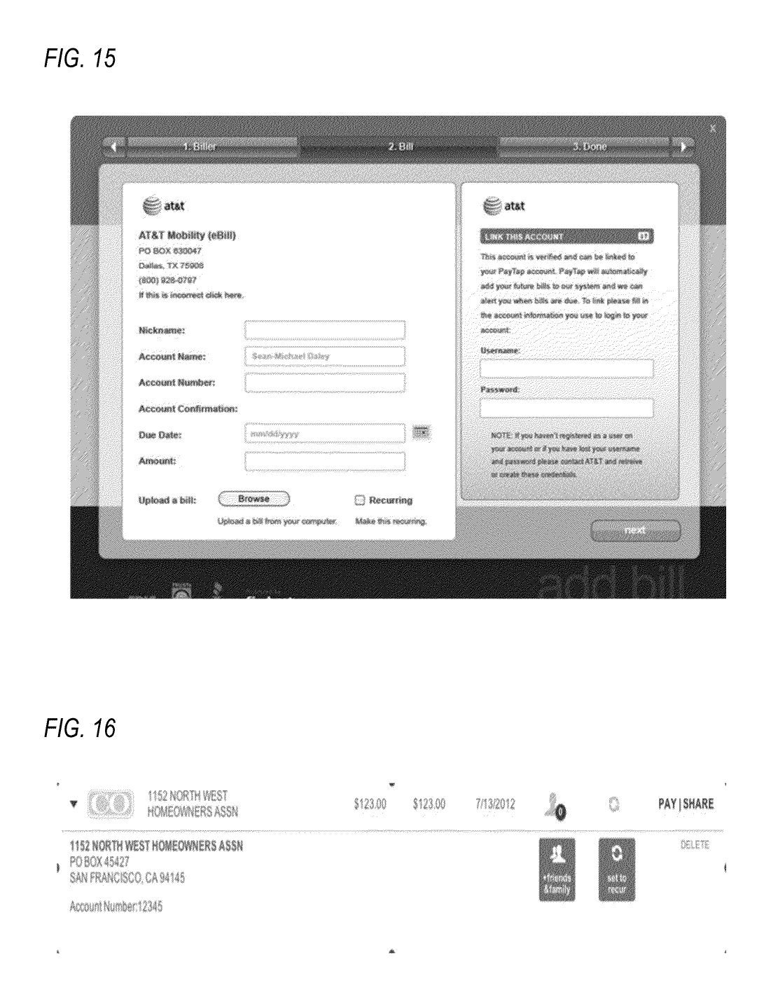

At block 204, the TTPP system 102 receives information regarding the billers and the bills of each bill owner. The TTPP system 102 provides a user interface to the bill owner device 104 that enables the bill owner to identify billers. The TTPP system 102 enables the bill owner to pick the biller from a list of billers known to the TTPP system 102. The pick list may include the list of billers with which the bill aggregator has relationships and has the biller financial account information needed to electronically transfer funds from the FBO account bank system 126 to the biller bank systems 128. These billers are referred to as verified billers because the bill aggregator has already verified the biller's legitimacy and bank account information. This approach advantageously reduces the likelihood of a fraudulent biller being able to receive payments from the TTPP system 102. Alternatively, the bill owner may manually enter the biller information. These billers are referred to as unverified billers. The trusted third party may subsequently verify the manually entered biller and then add the newly verified biller to the pick list of verified billers. FIG. 13 is a screen shot showing an example of the user interface provided to the bill owner for providing biller information. The biller information may include the biller name and address, as well as the bill owner account number, as shown in the screen shot of FIGS. 14-16. The trusted third party may also obtain the financial account information needed to electronically transfer funds from the FBO account to the biller bank system 128. Once the biller information is in the TTPP system 102, the bill owner provides to the TTPP system 102 information regarding a bill owed to the biller. The bill information may include the bill owner's name, account number, due date and amount due, as shown in the screen shot of FIGS. 14-16. In one embodiment, after a bill owner enters the bill information, the TTPP system 102 verifies the bill information with the biller, and if the bill is not valid, the TTPP system 102 does not allow bill helpers to pay the bill. In one embodiment, the bill owner may upload an image of the bill (e.g., a scanned image or photo) to the TTPP system 102 to enable the TTPP system 102 to display the image of the bill for potential bill helpers, as shown in FIG. 15. This enables the bill helpers to verify the validity of the bill. In one embodiment, the bill owner may authorize the TTPP system 102 to obtain the bill information directly from the biller systems 108. For example, the screen shot of FIG. 15 shows a user interface provided by the TTPP system 102 to the bill owner device 102 at which the bill owner may enter his AT&T Mobility account username and password in order to link the bill owner's account to the TTPP system 102 so that the TTPP system 102 can automatically add bills from the biller to the TTPP system 102 and alert the bill owner when the bills are due. Flow proceeds to block 206.

At block 206, TTPP system 102 sends a message to the potential bill helpers identified by the bill owner using the contact information received at block 202. The message indicates that the bill owner needs help paying bills. The TTPP system 102 may enable the bill owner at block 202 to create a customized message to be sent to the potential bill helpers or to pick a stock message created by the TTPP system 102, such as an email message, Facebook notification or Twitter tweet. The message may also include information that enables the bill helper to access the TTPP system 102 in order to view the bill information received at block 204. For example, the message may include a link on which the bill helper may click which will take the potential bill helper to a website of the TTPP system 102. FIGS. 8, 10 and 12 are screen shots that illustrate an example of an email message, Facebook notification and Twitter tweet, respectively, provided to the potential bill helper, as discussed above with respect to block 202. Flow proceeds to block 208.

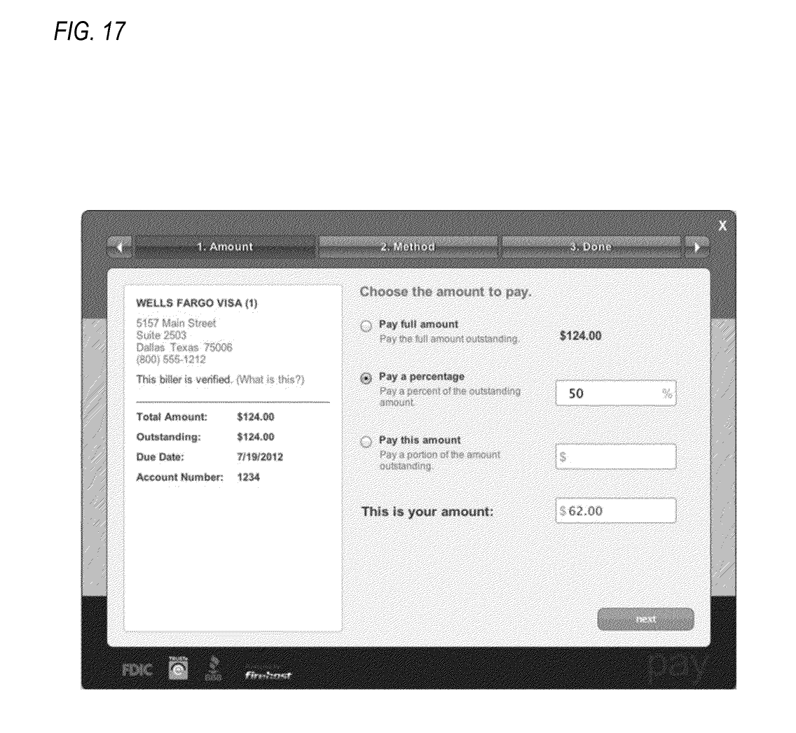

At block 208, bill helpers access the TTPP system 102 from bill helper devices 106 to pay bills for a bill owner. The TTPP system 102 receives from each bill helper for each bill the bill helper wants to pay the amount the bill helper wants to pay on the bill. Preferably, the bill helper can make a full payment or a partial payment of the bill, such as a percentage of the bill or a partial dollar amount, as shown in the screen shot of FIG. 17. In one embodiment, the TTPP system 102 enables the bill helper to specify a matching payment in which the bill helper pays an amount that matches the amount paid by other bill helpers and/or the bill owner himself. The matching payment may be contingent upon payment by the other payer or payers. In one embodiment, the TTPP system 102 enables the bill helper to specify that the bill payment should be recurrent. In one embodiment, as a bill helper makes a payment, the outstanding amount due on the bill that is shown to bill helpers is reduced by the amount paid, and the TTPP system 102 does not allow a bill helper to pay more than the outstanding amount. Advantageously, this reduces the likelihood of bill helpers overpaying the bill. Preferably, if the biller makes a refund back to the TTPP system 102, the TTPP system 102 subsequently makes the refund back to the bill helper rather than to the bill owner. Flow proceeds to block 212.

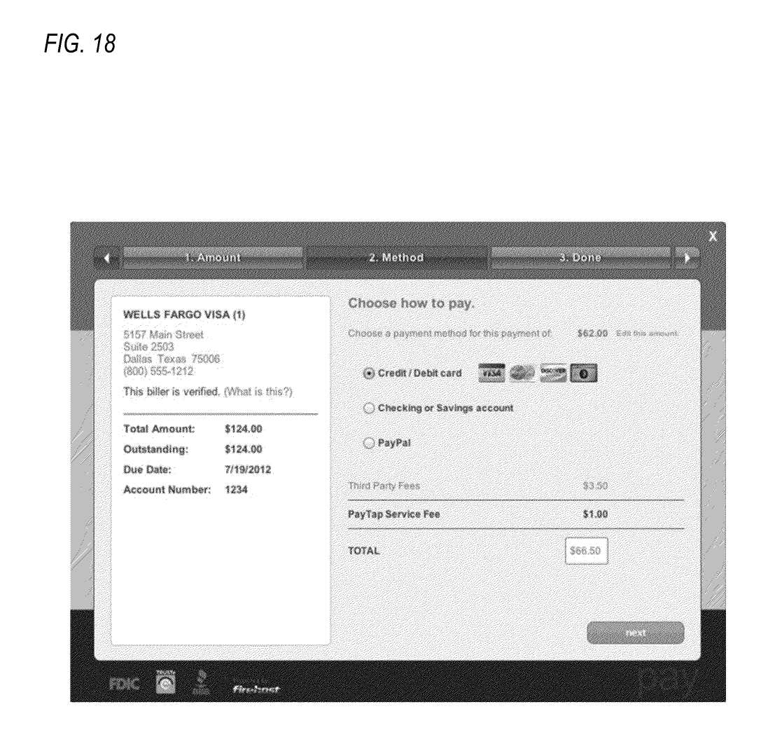

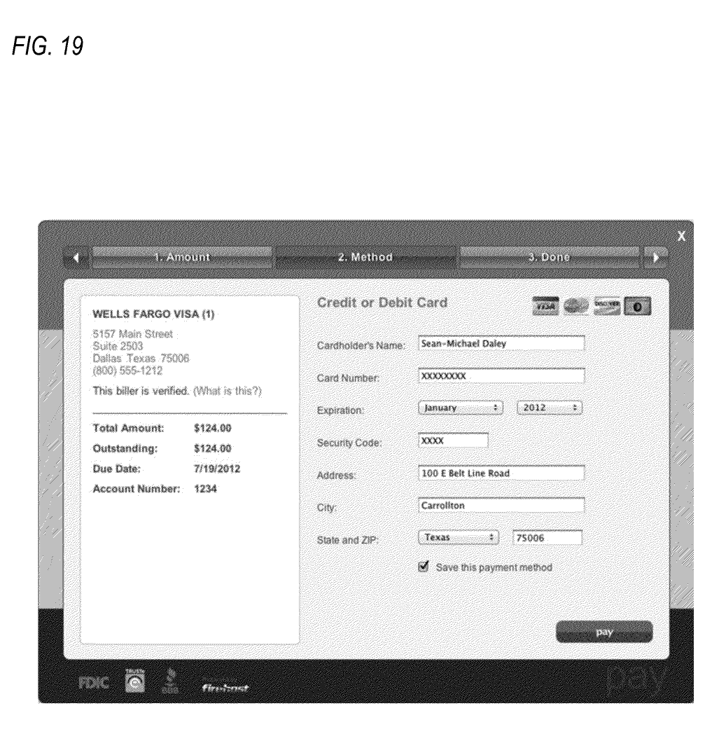

At block 212, the TTPP system 102 receives from the bill helper payment instrument information of the bill helper. Preferably, the bill helper first selects a payment method, or payment instrument, such as a credit or debit card, checking or savings account (commonly referred to as an automatic clearing house (ACH) payment), or other payment method such as PayPal® or other “electronic wallet” online payment system, as shown in the screen shot of FIG. 18. Once the bill helper selects a payment instrument, the TTPP system 102 calculates the fees that it will charge to the bill helper for the services provided and communicates fees to the bill helper, as shown in FIG. 18. The fees that may be charged include, but are not limited to, the following. The TTPP system 102 may charge a fee per bill payment for the services provided by the TTPP system 102, which may be a fixed amount per bill payment (e.g., one dollar, as shown in FIG. 18) or may be a percentage of the payment amount, for example. The TTPP system 102 may also pass on to the bill helper third party transaction fees (shown in FIG. 18 as $3.50) charged to the TTPP system 102 for paying the bill, such as transaction fees charged by the e-commerce gateway system 112, the credit/debit card company systems 114, and the biller aggregator systems 122. Because the third party transaction fees incurred by the TTPP system 102 may vary with the payment instrument type, the fees passed on to the bill helper by the TTPP system 102 may also vary accordingly. If the bill helper does not accept the fees, the payment is cancelled. Otherwise, the TTPP system 102 proceeds with the payment process. According to other embodiments, the TTPP system 102 charges at least a portion of the fees to the biller and/or bill owner, rather than or in addition to the bill helper. After selecting a payment instrument, the bill helper provides information about the payment instrument. In the case of a credit/debit card, the payment instrument information may include the name of the card holder (i.e., the bill helper), the card number, the expiration date, security code and mailing address, as shown in the screen shot of FIG. 19. In the case of an ACH payment, the payment instrument information may include the routing number of the bank 116 at which the account is held, the account number and the name of the account holder (i.e., the bill helper). In the case of a PayPal payment, preferably the TTPP system 102 directs the bill helper to the PayPal website where the bill helper makes a PayPal payment to the trusted third party's PayPal account. Flow proceeds to block 214.

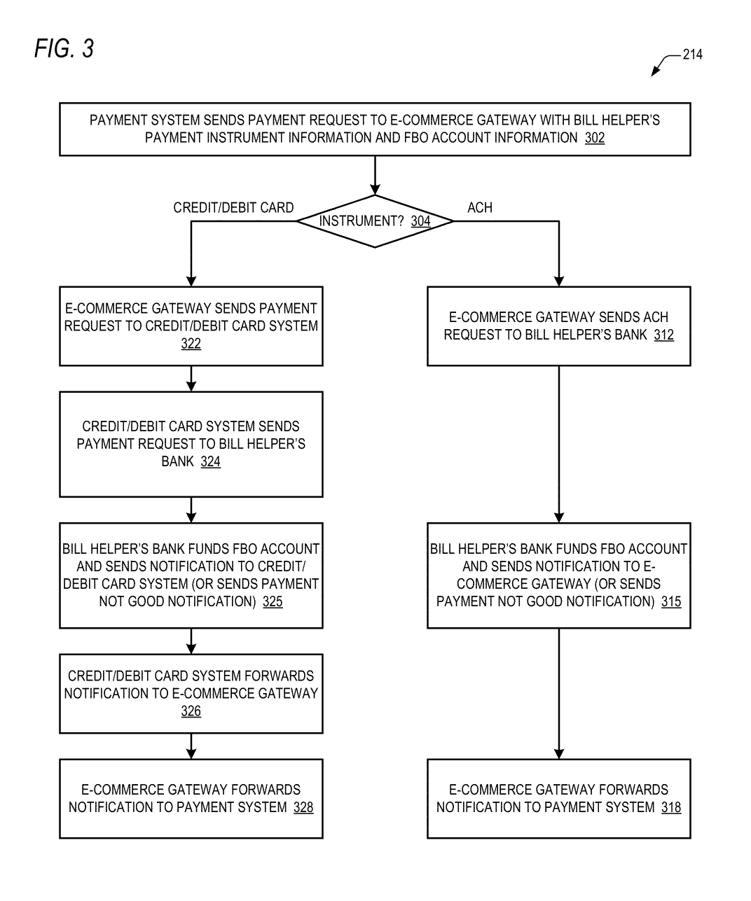

At block 214, the TTPP system 102 requests that payment be made by the bill helper's financial institution 116 to the FBO account at the FBO account bank system 126. Preferably, the payment request includes a payment amount that is equal to the sum of the amount the bill helper indicated it would pay on the bill of the bill owner at block 208 and the fee communicated at block 212. The operation of block 214 is described in more detail below with respect to FIG. 3. Flow proceeds to decision block 216.

At decision block 216, the TTPP system 102 determines the status of the payment requested at block 214. That is, the TTPP system 102 determines whether the bill helper's bank system 116 made the payment to the FBO account system 126. For example, the TTPP system 102 may receive a message from the e-commerce gateway system 112, as discussed with respect to FIG. 3, which indicates the payment request was made. On the other hand, the TTPP system 102 may receive a timeout from the e-commerce gateway system 112 or an indication that the bill helper's account has insufficient funds, was closed, or has exceeded its credit limit. If the TTPP system 102 determines that the payment was made, flow proceeds to block 222; otherwise, flow proceeds to block 218.

At block 218, the TTPP system 102 cancels the payment and notifies the bill helper that the payment was cancelled. Flow ends at block 218.

At block 222, the bill helper bank system 116 funds the FBO account 126. Flow proceeds to block 224.

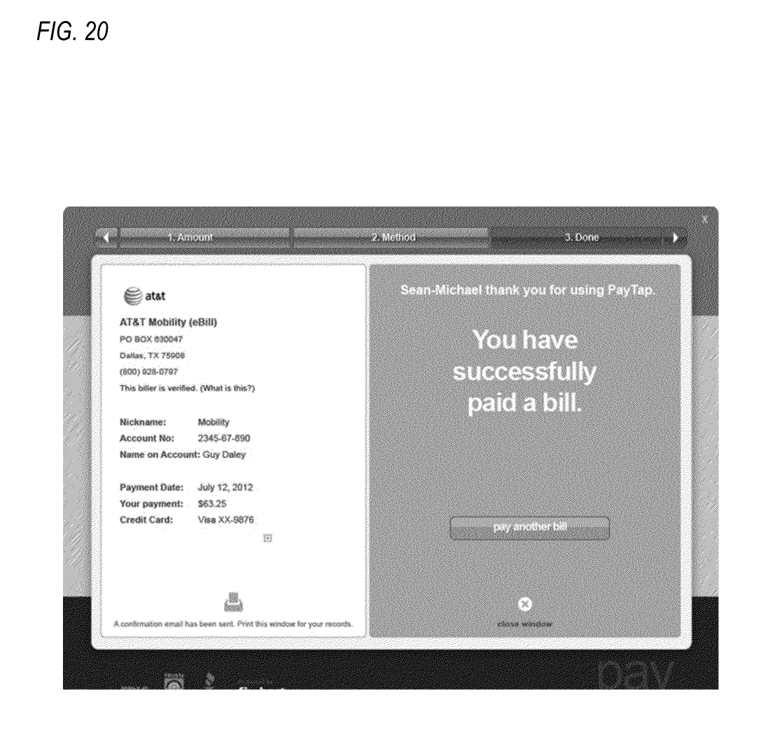

At block 224, the TTPP system 102 provides to the bill helper a receipt of the payment. FIG. 20 is a screen shot that shows an example of confirmation provided to the bill helper by the TTPP system 102. Flow proceeds to block 226.

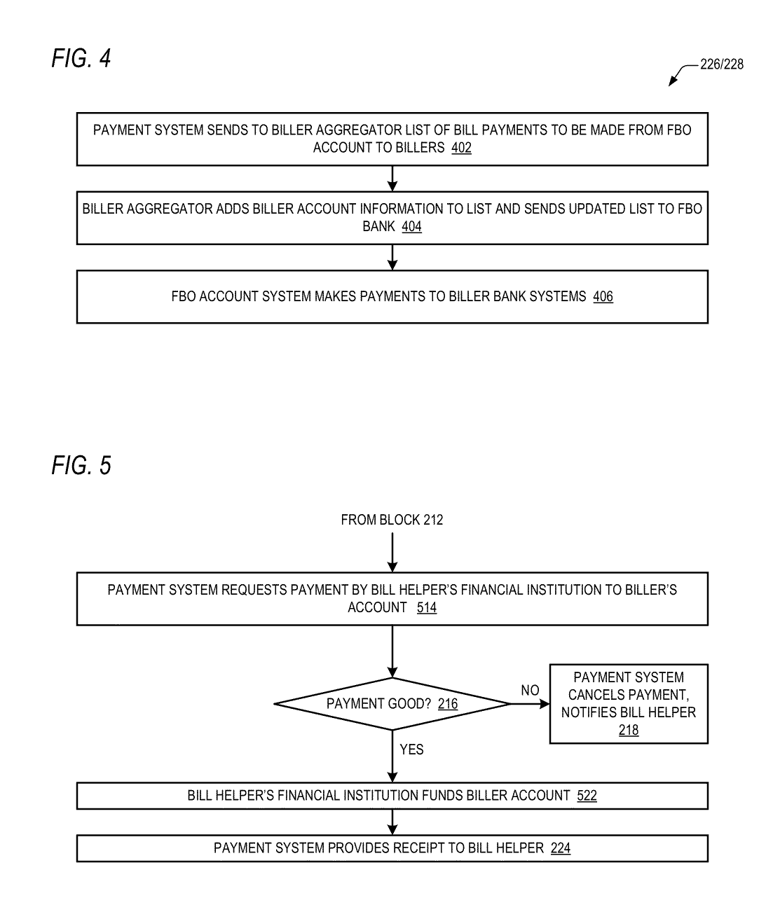

At block 226, the TTPP system 102 requests payment from the FBO account to the biller account at the biller bank system 128. In one embodiment, many payments are made at block 222 over the course of a day into the FBO account from many different bill helper financial accounts for many different bills of many different bill owners that accumulate in the FBO account. The accumulated payments may be of various types, as described above, e.g., credit/debit cards, ACH payments, PayPal payments. In one embodiment, in the case of an ACH payments, the TTPP system 102 may wait a few days after the bill helper authorizes payment on a bill to pay the biller bank system 128 in order to reduce the likelihood that the funds from the bill helper account bank system 116 are not available (e.g., the account was overdrawn or closed). Thus, if the bill helper chooses an ACH payment instrument at block 212 and the due date is within the number of days the TTPP system 102 waits to pay the bill, the TTPP system 102 gives the bill helper the opportunity to pay by another method. The operation of block 226 is described in more detail below with respect to FIG. 4. Flow proceeds to block 228.

At block 228, a payment is made from the FBO account to the biller account at the biller bank system 128. The operation of block 228 is also described below with respect to FIG. 4. Flow ends at block 228.

Although portions of FIG. 2 may describe the flow through the TTPP system 102 of a single payment of a single bill by a single bill helper of a single bill owner to a single biller, it should be understood that one or more bill owners may each post one or more bills owed to one or more billers to the TTPP system 102, and one or more bill helpers may pay one or more bills for one or more bill owners via the TTPP system 102. Furthermore, a bill helper may make a partial payment of a bill.

Referring now to FIG. 3, a flowchart illustrating in more detail the operation at block 214 of FIG. 2 according to one embodiment of the present invention is shown. Flow begins at block 302.

At block 302, the TTPP system 102 sends a payment request to the e-commerce gateway system 112 with the payment amount obtained at block 208 (including fees, as described herein), the bill helper payment instrument information obtained at block 212 and the FBO account information. If the bill helper elects to pay using an online payment service, such as PayPal, the TTPP system 102 redirects the bill helper's device 106 to the PayPal website where the bill helper makes a payment to the PayPal account of the trusted third party and receives a payment confirmation from the PayPal system. Subsequently, the TTPP transfers the payment amount (less fees) to the FBO account bank system 126. Flow proceeds to decision block 304.

At decision block 304, if the payment instrument is a credit/debit card, flow proceeds to block 322; otherwise, if an ACH transaction, e.g., checking or savings account, flow proceeds to block 312.

At block 312, in response to receiving the request sent at block 302, the e-commerce gateway system 112 sends to the bill helper bank system 116 an ACH request to transfer funds from the bill helper's checking or savings account account to the FBO account. Flow proceeds to block 315.

At block 315, in response to receiving the request sent at block 312, the bill helper bank system 116 funds the FBO account from the bill helper's account and sends a notification to the e-commerce gateway system 112 that the payment was made, or sends a notification that the payment was not good (e.g., insufficient funds, credit limit exceeded). Flow proceeds to block 318.

At block 318, the e-commerce gateway system 112 forwards the notification sent by the bill helper bank system 116 at block 315 to the TTPP system 102. Flow ends at block 318.

At block 322, in response to receiving the request sent at block 302, the e-commerce gateway system 112 sends to the credit/debit card system 114 a request to transfer funds from the bill helper's credit/debit card account to the FBO account. Flow proceeds to block 324.

At block 324, in response to receiving the request sent at block 322, the credit/debit card system 114 sends to the bill helper bank system 116 (i.e., the bank that issued the credit/debit card to the bill helper) a request to transfer funds from the bill helper's credit/debit card account to the FBO account. Flow proceeds to block 325.

At block 325, in response to receiving the request sent at block 324, the bill helper bank system 116 funds the FBO account from the bill helper's credit/debit account and sends a notification to the credit/debit card system 114 that the payment was made, or sends a notification that the payment was not good. Flow proceeds to block 326.

At block 326, the credit/debit card system 114 forwards the notification sent by the bill helper bank system 116 at block 325 to the TTPP system 102. Flow proceeds to block 328.

At block 328, the e-commerce gateway system 112 forwards the notification forwarded by the credit/debit card system 114 at block 326 to the TTPP system 102. Flow ends at block 328.

Referring now to FIG. 4, a flowchart illustrating in more detail the operation at blocks 226 and 228 of FIG. 2 according to one embodiment of the present invention is shown. Flow begins at block 402.

At block 402, the TTPP system 102 sends to the biller aggregator system 122 a list of bill payments to be made from the FBO account to the various biller bank systems 128. As discussed herein, the biller may agree to pay the trusted third party a fee per bill payment for the benefits provided by the TTPP system 102, in which case the TTPP system 102 deducts the fee from the amount of the bill payment from the FBO account to the biller. Furthermore, as discussed herein, the biller may agree to pay to the trusted third party transaction processing fees, or a portion thereof, associated with a given bill payment, in which case the TTPP system 102 deducts the fee from the amount of the bill payment from the FBO account to the biller. Additionally, for billers who accept partial payments, the TTPP system 102 may cause partial payments of a given bill to be made from the FBO account to the biller. This may be particularly beneficial to the bill owner if the biller is charging the bill owner interest on a daily basis. Flow proceeds to block 404.

At block 404, the biller aggregator system 122, which has the account information for each biller, takes the list received from the TTPP system 102 at block 402 and adds the biller's account information to each bill payment. The biller aggregator system 122 then sends the updated list to the FBO account bank system 126. In one embodiment, the biller aggregator system 122 sends a file, referred to as a “FED-ready file,” that includes a list of single line entry ACH debit transactions to be made from the FBO account system 126 to the biller bank systems 128. The bill aggregator system 122 may consolidate payments to the same biller. In one embodiment, if the biller is one for which the TTPP system 102 does not have the information necessary to make an electronic funds transfer to the biller bank system 128, the biller aggregator system 122 generates a physical check and mails it to the biller at the address provided by the bill owner at block 204. Flow proceeds to block 406.

At block 406, the FBO account bank system 126 makes the bill payments specified in the list sent at block 404 to the biller bank systems 128. Flow ends at block 406.

Referring now to FIG. 5, a flowchart illustrating operation of the TTPP system 102 of FIG. 1 to facilitate payment to billers of bill owner bills by bill helpers according to an alternate embodiment of the present invention is shown. In the embodiment of FIG. 5, the biller has a relationship with the trusted third party such that the TTPP system 102 facilitates direct transfers from the bill helper bank system 116 to the biller bank system 128 rather than indirectly through the FBO account. FIG. 5 is similar to FIG. 2 and like-numbered blocks indicate like operations. For simplicity, blocks 202 through 212 are not shown; blocks 226 and 228 are not included; block 214 is replaced by block 514; and block 222 is replaced by block 522.

At block 514, the TTPP system 102 requests that payment be made by the bill helper's financial institution to the biller's account at the biller bank system 128. Processing of the request made at block 514 is similar to the processing described with respect to FIG. 3, except that the biller's account at the biller bank system 128 is the target of the payment rather than the FBO account. That is, the biller has provided its merchant ID to the TTPP system 102 and has authorized the TTPP system 102 to accept payments on its behalf. Flow proceeds to decision block 216.

At block 522, the bill helper bank system 116 funds the biller's account in the biller bank system 128. Flow proceeds to block 224.

It should be understood that the TTPP system 102 may operate simultaneously according to the operations described with respect to FIG. 2 and FIG. 5. That is, the TTPP system 102 may have a direct biller relationship with some billers and operate according to FIG. 5 with those billers, whereas it may operate according to FIG. 2 with other billers with whom it does not have a direct biller relationship.

The following potential advantages may be provided by various embodiments described herein.

The TTPP system 102 provides the ability for the bill helpers to know that the money they are paying is going directly to the creditor (biller), rather than the bill owner, and is not being used for another purpose. This may foster the giving of more help than would otherwise be given.

The TTPP system 102 may increase the likelihood that billers are paid the money owed to them and therefore that the bill owners continue to receive the goods or services the billers provide.

Increasing the likelihood that billers are paid may in turn motivate billers to absorb some or all of the transaction costs associated with the payments, thereby reducing the cost of helping pay bills. This may foster the giving of more help than would otherwise be given.

The TTPP system 102 makes it easier for a person who needs help paying their bills (bill owner) to be found by people or organizations (bill helpers) that want to help the person in need. This may foster the giving of more help than would otherwise be given.

The TTPP system 102, because it does not require the bill helper to know or obtain the bill and biller information, reduces the time and energy the bill helper must expend in paying a bill owner's bill. This may foster the giving of more help than would otherwise be given.

The TTPP system 102, particularly embodiments in which the biller directly provides the bill information to the TTPP system 102, may increase the bill helper's confidence that bill amount is correct, i.e., that the need really exists. This may foster the giving of more help than would otherwise be given.

The TTPP system 102 may reduce the amount of embarrassment or shame involved in asking for help by the bill owners. This may foster the giving of more help than would otherwise be given.

The TTPP system 102 may enable to the bill helpers to understand the longer term needs of the bill owner and therefore more effectively plan to help the bill owner. This may foster the giving of more help than would otherwise be given.

The TTPP system 102 may reduce costs of helping pay bills relative to more traditional methods of helping. For example, the fees charged to use the TTPP system 102 may be less than the fees that must be paid in more traditional systems, such as money wire transfers, fees charged by bill paying entities, and so forth. This may foster the giving of more help than would otherwise be given.

The TTPP system 102 may enable bill helpers to pay bills for bill owners are who simply physically unable to pay their bills, e.g., due to a medical condition or being out of the country.

The TTPP system 102 may foster the sharing of payments by multiple bill helpers on a given bill, particularly since the bill helpers have more visibility into the fact that a portion of the bill is being paid by other bill helpers. For example, if a bill helper sees that $75 of a $100 bill has been paid, the bill helper may be willing to pay the remaining $25. This may foster the giving of more help than would otherwise be given.

Although embodiments have been described in which the bill selected by the bill helper to pay for the bill owner is money already owed by the bill owner to the biller, other embodiments are contemplated in which the “bill” selected is an account held by the bill owner into which the bill helper may deposit funds for the benefit of the bill owner. For example, the “bill” selected by the bill helper may be a pre-paid debit card account held by the bill owner into which the bill helper may deposit funds for the benefit of the bill owner. In this case, the “biller” is a debit card issuer, such as Akimbo, Walmart®, or other pre-paid debit card issuer. Preferably, the TTPP system 102 displays for bill helpers of the bill owner the balance on the debit card and the transactions (i.e., expenditures and deposits) made on the debit card to give bill helpers visibility into how the card is being used.

Although embodiments have been described in which the bill owner is known to the TTPP system 102 (i.e., the bill helper responds to an invitation to help a particular bill owner or the bill helper, e.g., organization or individual, selects a bill owner to help from a list of needy bill owners provided by the TTPP system 102), other embodiments are contemplated in which the “bill owner” is unknown to the TTPP system 102. Rather, the bill selected by the bill helper to fund is an account held by a biller into which the bill helper may deposit funds for the benefit of qualified “bill owners” that may draw from the biller's account if they have predetermined characteristics. For example, the biller may be a pharmacy into whose account bill helpers make “payments.” Subsequently, customers of the pharmacy needing medication may draw from the account at the pharmacy if they meet criteria established by the trusted third party and/or the pharmacy. The TTPP system 102 displays for bill helpers the balance in the account. Alternatively, the account is linked to a particular “bill owner” at the pharmacy, in which case the TTPP system 102 also displays for bill helpers of the bill owner the transactions (i.e., expenditures and deposits) made on the account, within limitations imposed by laws regarding the privacy of healthcare records.

While various embodiments of the present invention have been described herein, it should be understood that they have been presented by way of example, and not limitation. It will be apparent to persons skilled in the relevant project management arts that various changes in form and detail can be made therein without departing from the scope of the invention. Thus, the present invention should not be limited by any of the exemplary embodiments described herein, but should be defined only in accordance with the following claims and their equivalents. Finally, those skilled in the art should appreciate that they can readily use the disclosed conception and specific embodiments as a basis for designing or modifying other structures for carrying out the same purposes of the present invention without departing from the scope of the invention as defined by the appended claims.

I claim:

1. A trusted third party payment system, comprising:
one or more network interfaces, configured to communicate with a device to receive bill information about bills of a bill owner and to communicate with a plurality of devices to receive payment instrument information of each of a plurality of bill helpers, wherein the one or more network interfaces are further configured to communicate with systems operated by billers to whom the bills are owed by the bill owner; and
a central processing unit (CPU), configured to use the payment instrument information to pay the bills to the systems operated by the billers with funds of the bill helpers;
wherein the bill owner, the bill helpers, the billers and the trusted third party are all distinct entities.

2. The trusted third party payment system of claim 1, wherein for at least one of the bills, the CPU pays partial amounts of the bill with funds of each of the plurality of bill helpers.

3. The trusted third party payment system of claim 1, wherein the system is further configured to receive contact information of the bill helpers and to electronically communicate to the bill helpers, using the contact information, that the bill owner has requested help paying the bills.

4. The trusted third party payment system of claim 3, wherein to electronically communicate to the bill helpers, the system transmits to each of the bill helpers a message from at least one of the following list: an email message, a cell phone text message, and a social media message.

5. The trusted third party payment system of claim 1, wherein to pay the bills with funds of the bill helpers, the system electronically transfers the funds directly to an account of the biller.

6. The trusted third party payment system of claim 1, wherein to pay the bills with funds of the bill helpers, the system electronically transfers the funds to a holding account and pays the bills from the holding account.

7. The trusted third party payment system of claim 6, wherein to pay the bills from the holding account, the system electronically transfers the funds from the holding account to the systems operated by the billers.

8. The trusted third party payment system of claim 6, wherein to pay the bills from the holding account, the system generates a check from the holding account to pay the biller.

9. The trusted third party payment system of claim 6, wherein the holding account is an account distinct from an account identified by the payment instrument information and distinct from an account of the biller.

10. The trusted third party payment system of claim 6, wherein the holding account is an account held by a money transmitter that holds a money transfer license in each jurisdiction, where required, in which money is transferred into or out of the holding account.

11. The trusted third party payment system of claim 10, wherein the trusted third party is a sub-licensee of the money transmitter.

12. The trusted third party payment system of claim 1, wherein to receive the bill information about bills of the bill owner, the system receives the bill information from the bill owner.

13. The trusted third party payment system of claim 1, wherein to receive the bill information about bills of the bill owner, the system receives the bill information from the biller.

14. The trusted third party payment system of claim 1, wherein the system is further configured to provide the bill information to the bill helpers and to receive from each of the bill helpers an indication of which of the bills the bill helper will help pay.

15. The trusted third party payment system of claim 14, wherein the system is further configured to receive an indication that the bill helper will help pay a partial amount of the bill.

16. The trusted third party payment system of claim 15, wherein the system pays the partial amount by the bill helper contingent upon payment of a partial amount by the bill owner.

17. A method, comprising:
receiving, by a computer system, bill information about bills of a bill owner;
receiving, by the computer system, payment instrument information of each of a plurality of bill helpers; and
paying the bills, by the computer system, with funds of the bill helpers using the payment instrument information;
wherein the computer system is operated by a trusted third party;
wherein each of the bills is owed to a biller;
wherein the bill owner, the bill helpers, the billers and the trusted third party are all distinct entities.

18. The method of claim 17, wherein said paying the bills with funds of the bill helpers using the payment instrument information comprises:
for at least one of the bills, paying partial amounts of the bill with funds of each of the plurality of bill helpers using their associated payment instrument information.

19. The method of claim 17, further comprising:
receiving, by the computer system, contact information of the bill helpers; and
electronically communicating, by the computer system, to the bill helpers, using the contact information, that the bill owner has requested help paying the bills.

20. The method of claim 19, wherein said electronically communicating, by the computer system, to the bill helpers comprises transmitting to each of the bill helpers a message from at least one of the following list: an email message, a cell phone text message, and a social media message.

21. The method of claim 17, wherein said paying the bills with funds of the bill helpers using the payment instrument information comprises:
electronically transferring the funds using the payment instrument information directly to an account of the biller.

22. The method of claim 17, wherein said paying the bills with funds of the bill helpers using the payment instrument information comprises:
electronically transferring the funds using the payment instrument information to a holding account; and
paying the bills from the holding account.

23. The method of claim 22, wherein said paying the bills from the holding account comprises:
electronically transferring the funds from the holding account to an account of the biller.

24. The method of claim 22, wherein said paying the bills from the holding account comprises:
generating a check from the holding account to pay the biller.

25. The method of claim 22, wherein the holding account is an account distinct from an account identified by the payment instrument information and distinct from an account of the biller.

26. The method of claim 22, wherein the holding account is an account held by a money transmitter that holds a money transfer license in each jurisdiction in which money is transferred into or out of the holding account.

27. The method of claim 26, wherein the trusted third party is a sub-licensee of the money transmitter.

28. The method of claim 17, wherein said receiving the bill information about bills of the bill owner comprises:
receiving, by the computer system, the bill information from the bill owner.

29. The method of claim 17, wherein said receiving the bill information about bills of the bill owner comprises:
receiving, by the computer system, the bill information from the biller.

30. The method of claim 17, further comprising:
providing, by the computer system, the bill information to the bill helpers; and
receiving, by the computer system, from each of the bill helpers an indication of which of the bills the bill helper will help pay.

31. The method of claim 30, further comprising:
receiving, by the computer system, an indication that the bill helper will help pay a partial amount of the bill.

32. The method of claim 31, wherein payment of the partial amount by the bill helper is contingent upon payment of a partial amount by the bill owner.

33. A computer-readable memory medium comprising program instructions, wherein the program instructions are executable by a processor to implement:
receiving, by a computer system, bill information about bills of a bill owner;
receiving, by the computer system, payment instrument information of each of a plurality of bill helpers; and
paying the bills, by the computer system, with funds of the bill helpers using the payment instrument information;
wherein the computer system is operated by a trusted third party;
wherein each of the bills is owed to a biller;
wherein the bill owner, the bill helpers, the billers and the trusted third party are all distinct entities.

34. The computer-readable memory medium of claim 33, wherein the program instructions are executable by a processor to further implement:
for at least one of the bills, paying partial amounts of the bill with funds of each of the plurality of bill helpers using their associated payment instrument information.

35. The computer-readable memory medium of claim 33, wherein the program instructions are executable by a processor to further implement:
receiving, by the computer system, contact information of the bill helpers; and
electronically communicating, by the computer system, to the bill helpers, using the contact information, that the bill owner has requested help paying the bills.

36. A method, comprising:
receiving, by a computer system, payment instrument information of each of a plurality of contributors; and
funding, by the computer system, a debit card in the name of a person, with funds of the contributors using the payment instrument information;
wherein the computer system is operated by a trusted third party;
wherein the person, the contributors and the trusted third party are all distinct entities.

37. A method, comprising:
receiving, by a computer system, bill information about a bill of a bill owner;
electronically communicating, by the computer system, to a bill helper, using the contact information, that the bill owner has requested help paying the bill;
receiving, by the computer system, payment instrument information of the bill helper; and
paying the bill, by the computer system, with funds of the bill helper using the payment instrument information;
wherein the computer system is operated by a trusted third party;
wherein the bill is owed to a biller;
wherein the bill owner, the bill helper, the biller and the trusted third party are all distinct entities.

38. A method, comprising:
receiving, by a computer system, payment instrument information of each of a plurality of contributors; and
funding, by the computer system, an account held by an entity that provides goods and/or services, with funds of the contributors using the payment instrument information; and
withdrawing funds from the account in response the entity providing goods and/or services to beneficiaries;
wherein the computer system is operated by a trusted third party;
wherein the goods/services provider entity, the contributors, the beneficiaries and the trusted third party are all distinct entities.
